(19) United States
(12) Patent Application Publication
(10) Pub. No.: US 2005/0204630 A1
(43) Pub. Date: Sep. 22, 2005

(54) Shutter

(75) Inventor: Ming Nien, Changhua Hsien (TW)

Correspondence Address: BROWDY AND NEIMARK, P.L.L.C.;624 NINTH STREET, NW, SUITE 300, WASHINGTON, DC, 20001-5303, US

(73) Assignee: Nien Made Enterprise Co., Ltd., Taichung (TW)

(21) Appl. No.: 10/878,303

(22) Filed: Jun. 29, 2004

(30) Foreign Application Priority Data
Feb. 25, 2004 (CN) 2004200038871

(51) Int. Cl. E06B 7/08

(52) U.S. Cl. 49/74.1

(57) ABSTRACT

A shutter includes a frame having an open space, a set of louvers arranged pivotally and parallel within the open space, and a control rod coupled to the louvers for tilting the louvers to an open status and a close status. A top block of the frame includes an exposed stepped front wall having a uniform cross section along a transverse length thereof. The exposed front wall is provided with a flat receiving portion and a flat blocking portion. When tilted the louvers to the close status, the flat blocking portion blocks a gap between the set of louvers and the top block, and the flat receiving portion receives a top end of the control rod, preventing interference with movement of the control rod.

### BACKGROUND OF THE INVENTION

1. Field of the Invention

The present invention relates to a shutter for a window or door and more particularly, to a shutter having an improved top block thereof.

2. Description of the Related Art

A conventional shutter, as shown in FIGS. 1-3, comprises a frame 1, a set of louvers 2, and a control rod 3. The frame 1 is comprised of two stiles 4, 5, a top block 6 transversely connected between the stiles 4, 5 at the top, and a bottom block 7 transversely connected between the stiles 4, 5 at the bottom. The stiles 4, 5 and the top and bottom blocks 6, 7 define an open space. The louvers 2 are arranged in parallel within the open space inside the frame 1, each having two distal ends respectively pivoted to the stiles 4, 5. The control rod 3 is coupled to one side edge of each of the louvers 2. Moving the control rod 3 upwards or downwards tilts the louvers 2 to regulate the light.

As illustrated in FIG. 3, the top block 6 and the bottom block 7 have a respective flange 8 projecting into the open space within the frame 1. When tilted the louvers 2 to the close position, the two flanges 8 block the gap between the topside louver and the top block 6 and the gap between the bottom-side louver and the bottom block 7.

In order to have a nice look, the top block 6 has a certain thickness. When moving the control rod 3 upwards to tilt the louvers 2 to the close position, the thickness of the top block 6 limits the moving range of the control rod 3, thereby resulting in incomplete closing of the louvers 2. In order to eliminate this problem, a notch 9 must be made in the bottom side of the top block 6 for receiving the top end of the control rod 3 to extend the moving range of the control rod 3 so that the louvers 2 can be accurately tilted to the close position. However, the formation of the notch 9 requires an additional processing process. Normally, a miller is used to mill the top block 6, thereby forming a smoothly curved inner face 9a at the inner side of the notch 9. Further, the top end 3a of the control rod 9 is processed into a smoothly arched configuration that fits the smoothly curved inner face 9a of the notch 9. After milling, the rough surface of the smoothly curved inner face 9a must be polished. These complicated processing procedures greatly increase the manufacturing cost of the shutter. In addition, because the notch 9 is shaped like a mouse hole, it destroys the sense of beauty of the shutter. Further, when painting the shutter, it is not easy to cover the surface of the notch 9 with paint.

### SUMMARY OF THE INVENTION

It is the primary objective of the present invention to provide a shutter having an improved top block, which is easy and inexpensive to manufacture.

It is another objective of the present invention to provide a shutter, which provides an improved structure of top block, thereby lowering the cost of the component.

It is still another objective of the present invention to provide a shutter having an improved top block, which causes a sense of beauty.

To achieve these objectives of the present invention, the shutter comprises a frame, which defines an open space and, is comprised of two vertically extended parallel stiles, a transversely extended top block connected between the stiles at a top side, and a transversely extended bottom block connected between the stiles at a bottom side, a louver set, which comprises a plurality of louvers arranged in parallel within the open space, each louver having two distal ends respectively pivoted to the stiles; a control rod coupled to one sidewall of each of the louvers. Further, the top block comprises a stepped front wall exposed to the outside. The stepped front wall has a uniform cross section along a transverse length thereof, and is comprised of a flat receiving portion and a flat blocking portion. When tilted the louvers to close the louver set, the flat blocking portion blocks a gap between the louver set and the top block, and the flat receiving portion receives the top end of the control rod, preventing interference with movement of the control rod. According to this design, the top block is easy to make, diminishes much material consumption, and has a nice look.

### BRIEF DESCRIPTION OF THE DRAWINGS

FIG. 1 is a perspective view of a shutter according to the prior art.

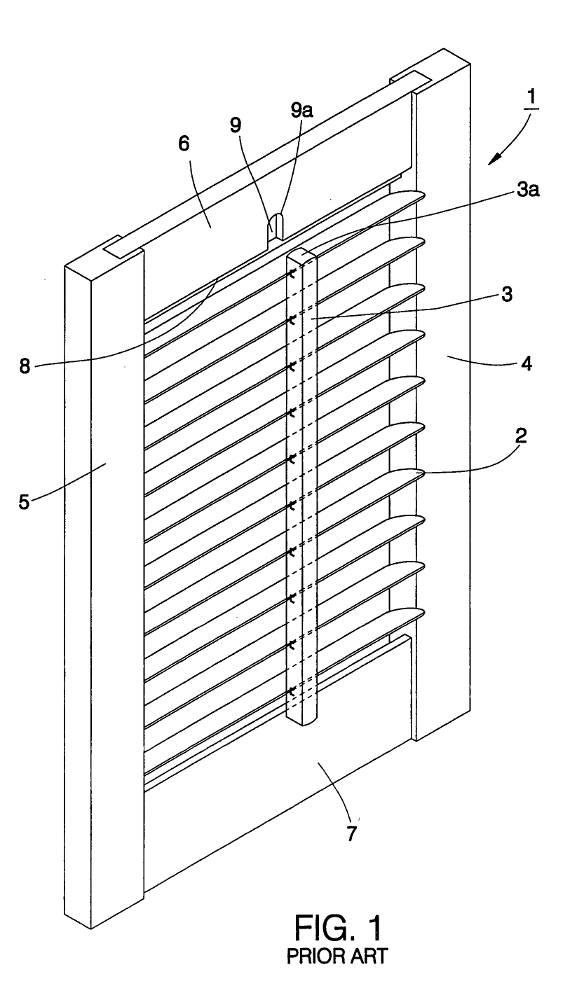

FIG. 2 is a front view of the prior art shutter, showing the louvers closed.

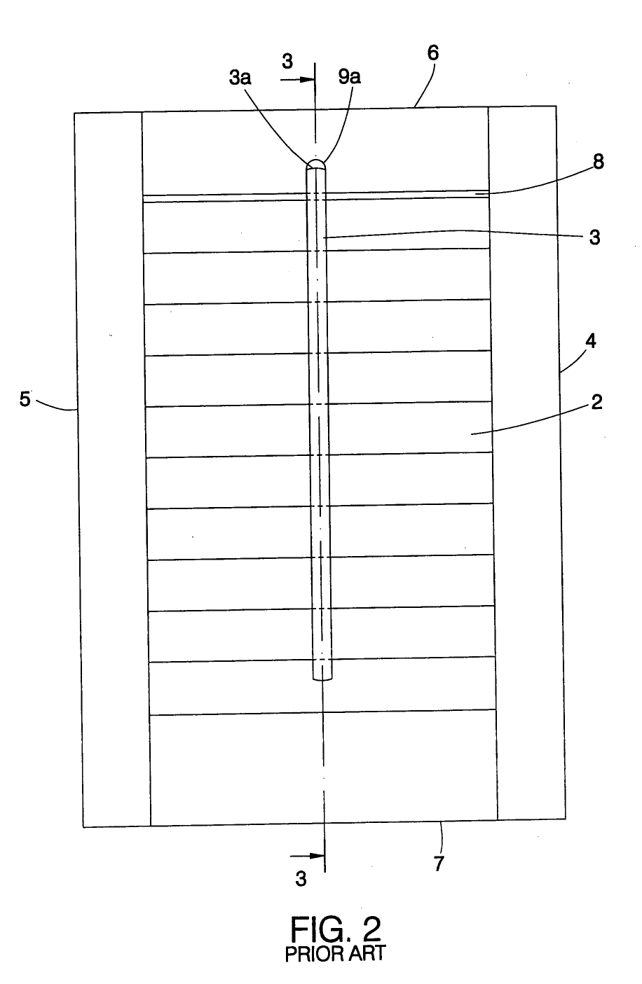

FIG. 3 is a sectional view taken along the line 3-3 of FIG. 2.

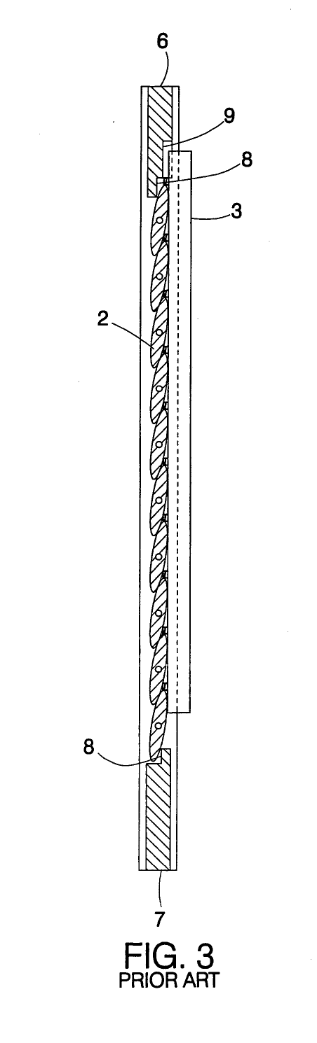

FIG. 4 is a perspective view of a shutter according to a first preferred embodiment of the present invention, showing the louvers opened.

FIG. 5 is a front view of the shutter according to the first preferred embodiment of the present invention, showing the louvers closed.

FIG. 6 is a sectional view taken along the line 6-6 of FIG. 5.

FIG. 7 is a perspective view of a shutter according to a second preferred embodiment of the present invention, showing the louvers opened.

FIG. 8 is a front view of the shutter according to the second preferred embodiment of the present invention, showing the louvers closed.

FIG. 9 is a sectional view taken along the line 9-9 of FIG. 8.

### DETAILED DESCRIPTION OF THE INVENTION

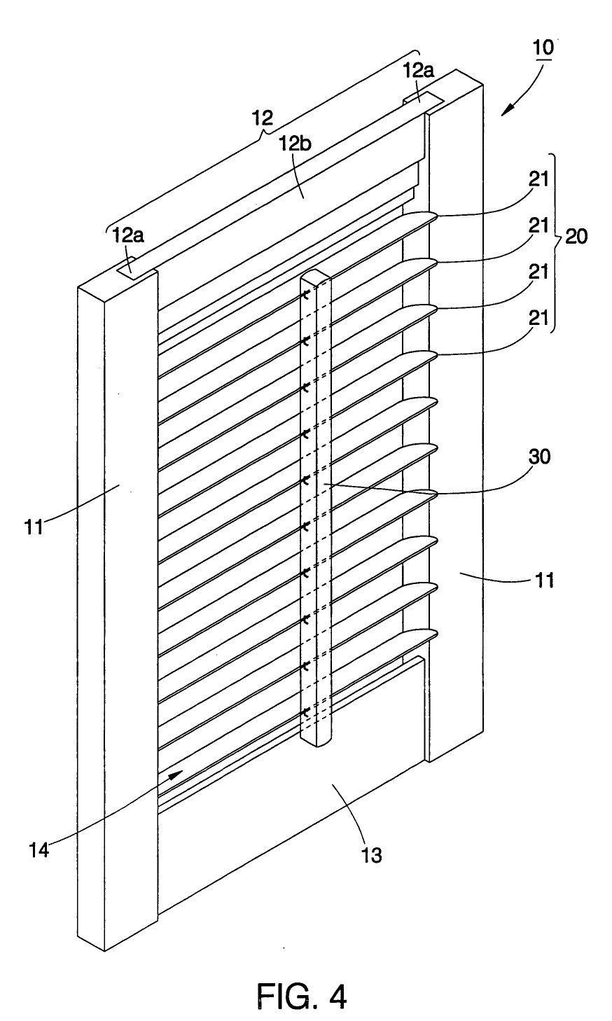

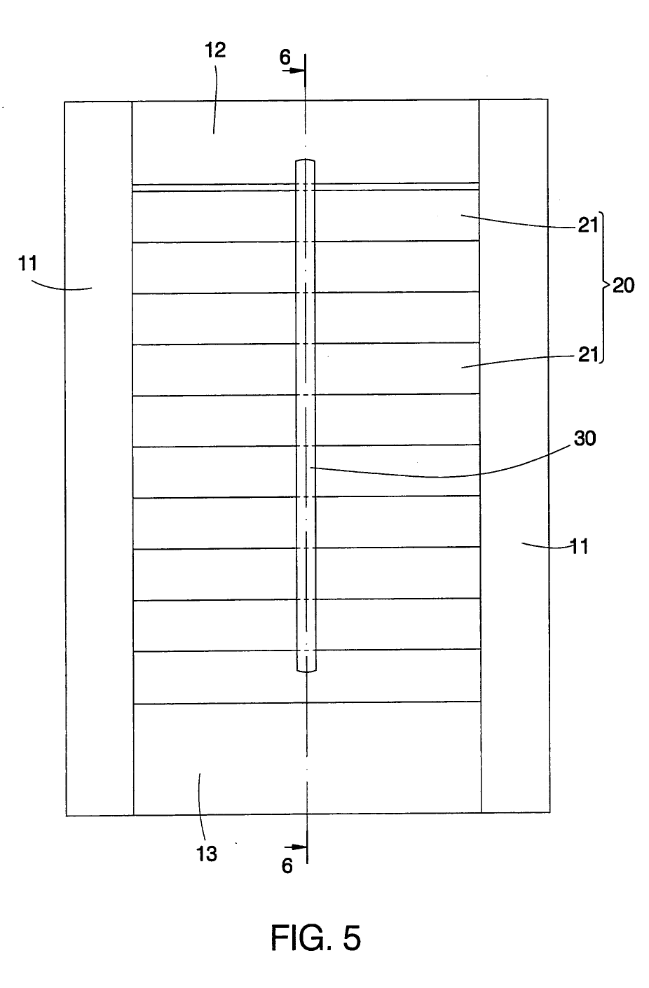

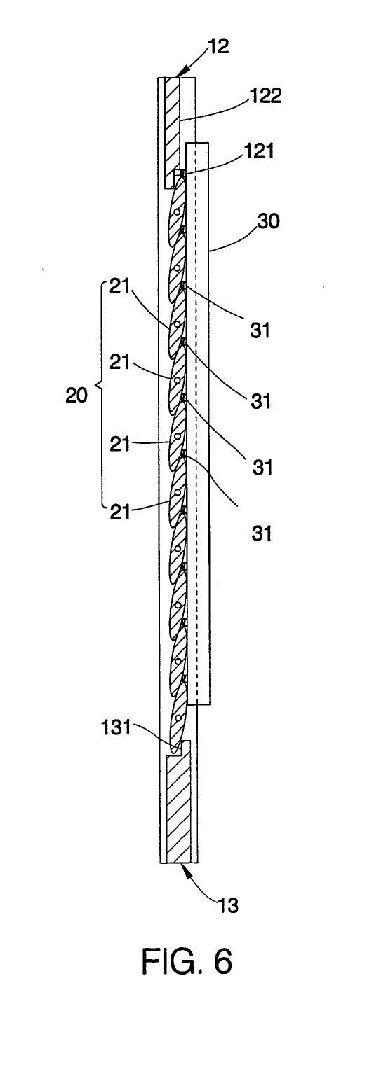

Referring to FIGS. 4-6, a shutter in accordance with the first preferred embodiment of the present invention is shown comprised of a frame 10, a louver set 20, and a control rod 30.

The frame 10 is comprised of two vertically extended parallel stiles 11, a transversely extended top block 12, and a transversely extended bottom block 13. The top block 12 is connected between the stiles 11 at the topside. The bottom block 13 is connected between the stiles 11 at the bottom side. The stiles 11 defines with the top block 12 and the bottom block 13 an open space 14.

The louver set 20 includes a plurality of louvers 21. The louvers 21 are arranged in parallel within the open space 14, each having two distal ends respectively pivoted to the stiles 11.

The control rod 30 is coupled to one sidewall of each of the louvers 21 by a plurality of hook-and-ring sets 31 spacedly respectively mounted at connections between the control rod 30 and the sidewalls of the louvers 21. When moving the control rod 30 with an external force, the louvers 21 are tilted to an open status or a close status.

The top block 12 has two insertion end portions 12a respectively engaged into the inside of the stiles 11, and a front wall 12b exposed to the outside. The front wall 12b is a stepped structure comprising a flat upper receiving portion 122 and a flat lower blocking portion 121. The upper receiving portion 122 rises above the lower blocking portion 121. When tilted the louvers 21 to close the louver set 20, the lower blocking portion 121 blocks the gap between the louver set 20 and the top block 12, and the upper receiving portion 122 receives the top end of the control rod 30 (actually, the top end of the control rod 30 is received in the space defined between the stiles 11 in front of the top block 12). Therefore, the top block 12 does not interfere with the movement of the control rod 30, and the control rod 30 can freely be moved to tilt the louvers 21 to completely close the louver set 20.

The bottom block 13 comprises a top flange 131 upwardly projecting into the open space 14. When closed the louver set 20, the top flange 131 blocks the gap between the bottom block 13 and the louver set 20.

According to the aforesaid first preferred embodiment of the present invention, the top block 12 can be made of a single piece of wooden block, which is cut into a stepped structure. Alternatively, the top block 12 can be formed of two rectangular wooden blocks of different thickness and area, i.e., the first rectangular wooden block, which forms the thickness of the lower blocking portion 121, and the second rectangular wooden block, which forms the thickness difference between the lower blocking portion 121 and the upper receiving portion 122. The first rectangular wooden block and the second rectangular wooden block are bonded to each other with an adhesive. This bonding method eliminates a complicated milling process, thereby effectively saves the manufacturing time and reduces the manufacturing cost.

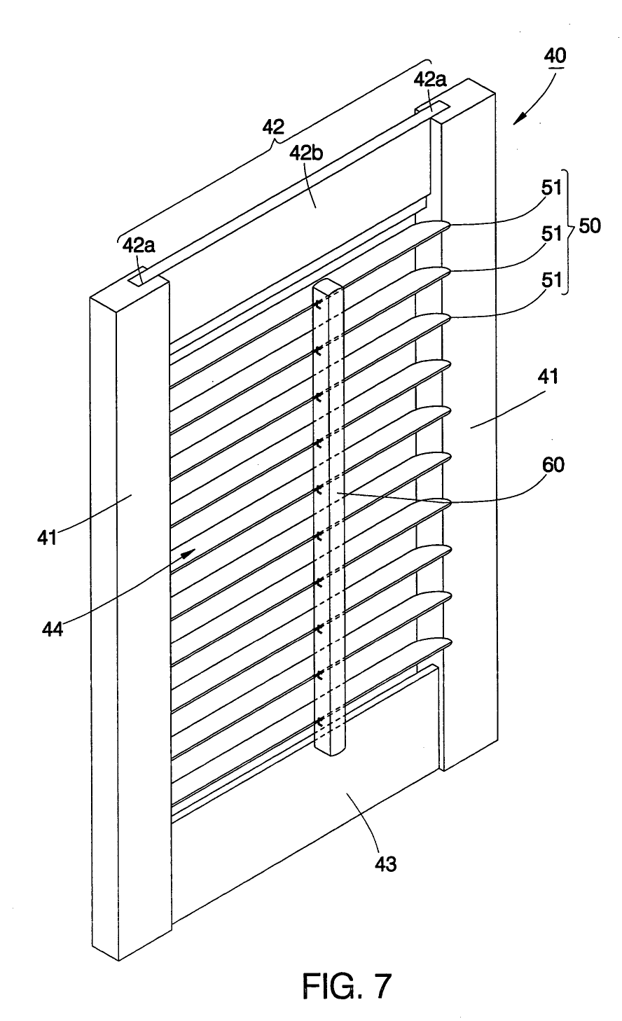

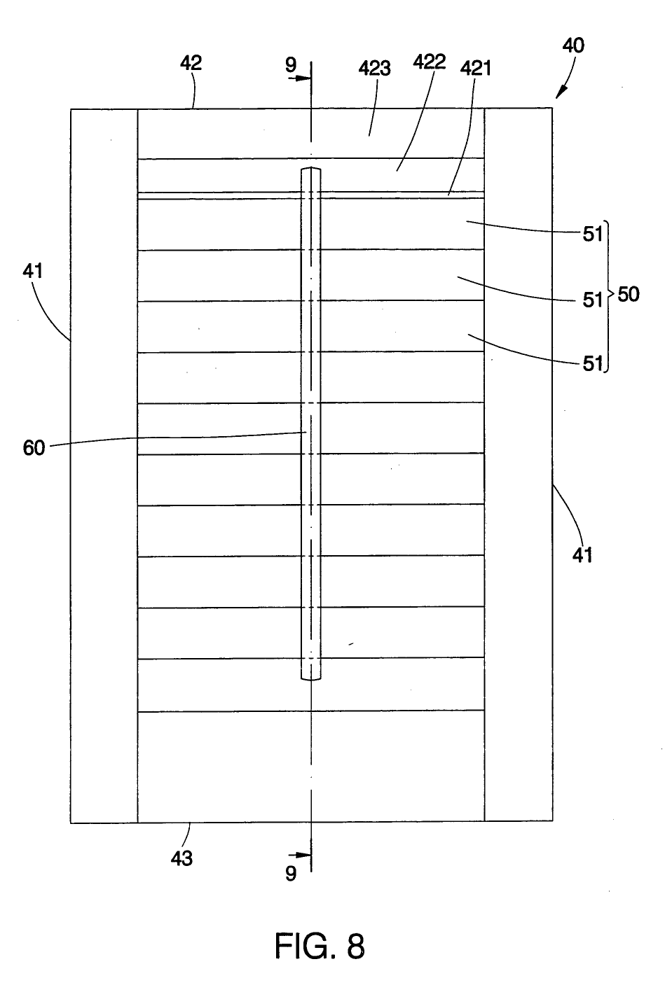

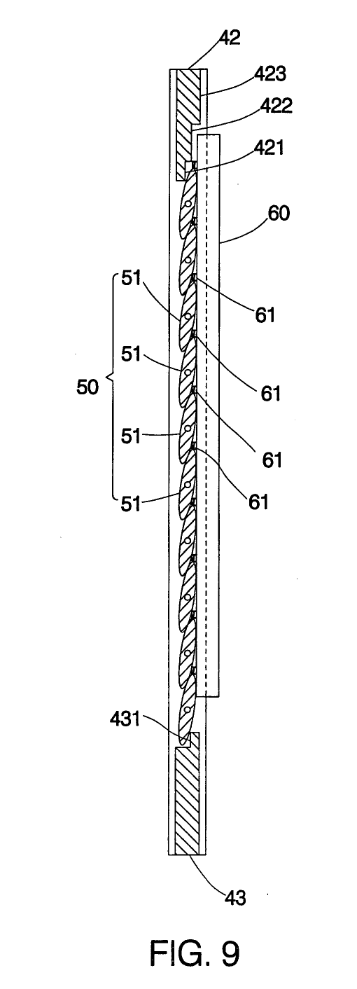

FIGS. 7-9 show a shutter according to the second preferred embodiment of the present invention. Similar to the aforesaid first preferred embodiment of the present invention, this second preferred embodiment is comprised of a frame 40, a louver set 50, and a control rod 60.

The frame 40 is comprised of two vertically extended parallel stiles 41, a transversely extended top block 42, and a transversely extended bottom block 43. The top block 42 is connected between the stiles 41 at the top. The bottom block 43 is connected between the stiles 41 at the bottom. The stiles 41 defines with the top block 42 and the bottom block 43 an open space 44.

The louver set 50 includes a plurality of louvers 51. The louvers 51 are arranged in parallel within the open space 44, each having two distal ends respectively pivoted to the stiles 41.

The control rod 60 is coupled to one sidewall of each of the louvers 51 by a plurality of hook-and-ring sets 61 spacedly respectively mounted at connections between the control rod 60 and the sidewalls of the louvers 51. When moving the control rod 60 with an external force, the louvers 51 are tilted to an open status or a close status.

The top block 42 has two insertion end portions 42a respectively engaged into the inside of the stiles 41, and a front wall 42b exposed to the outside. The front wall 42b is a stepped structure having a uniform cross section along its transverse length. The front wall 42b comprises a flat upper portion 423, a flat lower blocking portion 421, and a flat intermediate receiving portion 422. The upper portion 423 rises above the intermediate receiving portion 422. The intermediate receiving portion 422 rises above the lower blocking portion 421. When tilted the louvers 51 to close the louver set 50, the lower blocking portion 421 blocks the gap between the louver set 50 and the top block 42, and the intermediate receiving portion 422 receives the top end of the control rod 60 (actually, the top end of the control rod 60 is received in the space defined between the stiles 41 in front of the top block 42). Therefore, the top block 42 does not interfere with the movement of the control rod 60, and the control rod 60 can freely be moved to tilt the louvers 51 to completely close the louver set 50.

The bottom block 43 comprises a top flange 431 upwardly projecting into the open space 44. When closed the louver set 50, the top flange 431 blocks the gap between the bottom block 43 and the louver set 50.

According to the aforesaid second preferred embodiment of the present invention, the top block 42 can be made of a single piece of wooden block, which is cut into a three-step structure. Alternatively, the top block 42 can be formed of three rectangular wooden blocks of different thickness and area, i.e., the first rectangular wooden block, which forms the thickness of the lower blocking portion 421, the second rectangular wooden block, forms the thickness difference between the lower blocking portion 421 and the intermediate receiving portion 422, and the third rectangular wooden block, which forms the thickness difference between the intermediate receiving portion 422 and the upper portion 423. The three rectangular wooden blocks are bonded together with an adhesive. This bonding method eliminates a complicated milling process, thereby effectively saves the manufacturing time and reduces the manufacturing cost.

The spirit of the present invention is to have the exposed front wall of the top block exhibit a stepped structure having a uniform cross section along its transverse length for receiving the top end of the control rod, eliminating the complicated processing process of making a mouse hole in the top block, and diminishing material consumption. Further, because the receiving portion exhibits a flat surface, the sense of beauty of the outer appearance of the shutter is maintained intact.

Although particular embodiments of the invention have been described in detail for purposes of illustration, various modifications and enhancements may be made without departing from the spirit and scope of the invention. Accordingly, the invention is not to be limited except as by the appended claims.

1. A shutter comprising:
a frame having two vertically extended parallel stiles, a transversely extended top block connected between top sides of said stiles, and a transversely extended bottom block connected between bottom sides of said stiles, said stiles defining with said top block and said bottom block an open space;
a louver set having a plurality of louvers arranged in parallel within said open space, said louvers each having two distal ends respectively pivoted to said stiles;
a control rod coupled to each of said louvers for tilting said louvers to an open status and a close status;
wherein said top block comprises a front wall exposed to the outside, said front wall having a flat receiving portion and a flat blocking portion so arranged to form a stepped structure such that when tilted said louvers to the close status, said flat blocking portion blocks a gap between said louver set and said top block, and said flat receiving portion receives a top end of said control rod, preventing interference with movement of said control rod.

2. The shutter as claimed in claim 1, wherein said flat receiving portion is located above said flat blocking portion.

3. The shutter as claimed in claim 1, wherein said top block is integrally formed of one single piece.

4. The shutter as claimed in claim 1, wherein said top block is formed of a plurality of rectangular block members fastened together by bonding.

5. A shutter comprising:
a frame having two vertically extended parallel stiles, a transversely extended top block connected between top sides of said stiles, and a transversely extended bottom block connected between bottom sides of said stiles, said stiles defining with said top block and said bottom block an open space;
a louver set having a plurality of louvers arranged in parallel within said open space, said louvers each having two distal ends respectively pivoted to said stiles;
a control rod coupled to each of said louvers for tilting said louvers to an open status and a close status;
wherein said top block comprises a front wall exposed to the outside, said exposed front wall having a uniform cross section along a transverse length thereof and comprising a flat top portion, a flat receiving portion, and a flat blocking portion respectively rising one above another in proper order to form a three-step stepped structure such that when tilted said louvers to the close status, said flat blocking portion blocks a gap between said louver set and said top block, and said flat receiving portion receives a top end of said control rod, preventing interference with movement of said control rod.

6. The shutter as claimed in claim 5, wherein said flat receiving portion is located above said flat blocking portion.

7. The shutter as claimed in claim 5, wherein said top block is integrally formed of one single piece.

8. The shutter as claimed in claim 5, wherein said top block is formed of a plurality of rectangular block members fastened together by bonding.

9. A shutter comprising:
a frame having two vertically extended parallel stiles, a transversely extended top block connected between top sides of said stiles, and a transversely extended bottom block connected between bottom sides of said stiles, said stiles defining with said top block and said bottom block an open space;
a louver set having a plurality of louvers arranged in parallel within said open space, said louvers each having two distal ends respectively pivoted to said stiles;
a control rod coupled to each of said louvers for tilting said louvers to an open status and a close status;
wherein said top block comprises a front wall exposed to the outside, said front wall having a uniform cross section along a transverse length thereof and comprising a flat receiving portion and a flat blocking portion, said receiving portion and said flat blocking portion being arranged to form a stepped structure such that when tilted said louvers to the close status, said flat blocking portion blocks a gap between said louver set and said top block, and said flat receiving portion receives a top end of said control rod, preventing interference with movement of said control rod.

10. The shutter as claimed in claim 9, wherein said flat receiving portion is located above said flat blocking portion.

11. The shutter as claimed in claim 9, wherein said top block is integrally formed of one single piece.

12. The shutter as claimed in claim 9, wherein said top block is formed of a plurality of rectangular block members by bonding.
